(19) United States
(12) Patent Application Publication
(10) Pub. No.: US 2002/0016768 A1
(43) Pub. Date: Feb. 7, 2002

(54) Method of bill presentment and payment with a prepaid account

(76) Inventor: Blair Leavell, Weston, FL (US)

Correspondence Address: Gifford, Krass, Groh, Suite 400, 280 N. Old Woodward Ave., Birmingham, MI, 48009, US

(21) Appl. No.: 09/900,785

(22) Filed: Jul. 6, 2001

Related U.S. Application Data
(63) Continuation-in-part of application No. 09/721,322, filed on Nov. 22, 2000.
(63) Continuation-in-part of application No. 09/256,540, filed on Feb. 24, 1999.
(63) Continuation-in-part of application No. 09/457,653, filed on Dec. 9, 1999.
(63) Continuation-in-part of application No. 09/561,236, filed on Apr. 28, 2000.
(60) Provisional application No. 60/217,278, filed on Jul. 11, 2000.

(51) Int. Cl. G06F 17/60

(52) U.S. Cl. 705/40

(57) ABSTRACT

A system and method are described wherein consumers of goods and/or services tender payment to merchants via a public network such as the Internet. The payments are drawn from a prepaid account held by a financial institution. Importantly, the invention enables account reconciliation between the financial institution and the payee within a minimal time period, typically within one day.

### REFERENCE TO RELATED APPLICATION

This application claims priority of U.S. provisional patent application Serial No. 60/217,278, filed Jul. 11, 2000, and is a continuation-in-part of U.S. co-pending patent application Ser. No. 09/721,322, filed Nov. 22, 2000, which is a continuation-in-part of U.S. patent application Ser. No. 09/256,540, filed Feb. 24, 1999; U.S. patent application Ser. No. 09/457,653, filed Dec. 9, 1999; and U.S. patent application Ser. No. 09/561,236, filed Apr. 28, 2000, the entire contents of each being incorporated herein by reference.

### FIELD OF THE INVENTION

This invention relates generally to electronic payment transactions, and, more specifically, to a method and system for the timely payment and reconciliation of bills via a public network.

### BACKGROUND OF THE INVENTION

The current systems and methods of online bill payment and presentment between a consumer (payer), a merchant (payee), and a financial institution via the Internet require extended processing steps, including the steps of transferring funds debited from a consumer's account between the financial institution and a clearinghouse; holding the funds at the clearinghouse for several days; submitting batched transactions to a data mediator to convert payment data into a form acceptable to merchants for their accounts receivable processes; submitting electronic accounts receivable information from the data mediator to the merchant; and transferring electronic funds from the clearinghouse to the merchant's account.

The steps associated with current online payment methods of the type described above result in numerous transfers of data and electronic funds across one or more computer networks as well as lengthy delays. The numerous network transfers incur costs associated with network and system usage, communications media, and third party providers, such as the clearinghouse. The cumulative delays encountered while the clearinghouse holds the funds and the data mediator converts the payment data result in a prolonged transactional process lasting seven to twelve days. During this time and in lieu of payment, the merchant often institutes collection proceedings against the consumer in an attempt to collect the debt. The consumer, in turn, holds the financial institution responsible for the delays, resulting in customer dissatisfaction and lost business revenue for the financial institution.

### SUMMARY OF THE INVENTION

The present invention provides a system and method wherein consumers of goods and services present payment to merchants via a public network such as the Internet. The payments are drawn from a prepaid account held by a financial institution. The present invention further provides a system and method that enable account reconciliation between the financial institution and the payee within a minimal time period, typically within one day.

### BRIEF DESCRIPTION OF THE DRAWING

FIG. 1 depicts a flow diagram illustrating a process according to the invention in conjunction with a transaction server.

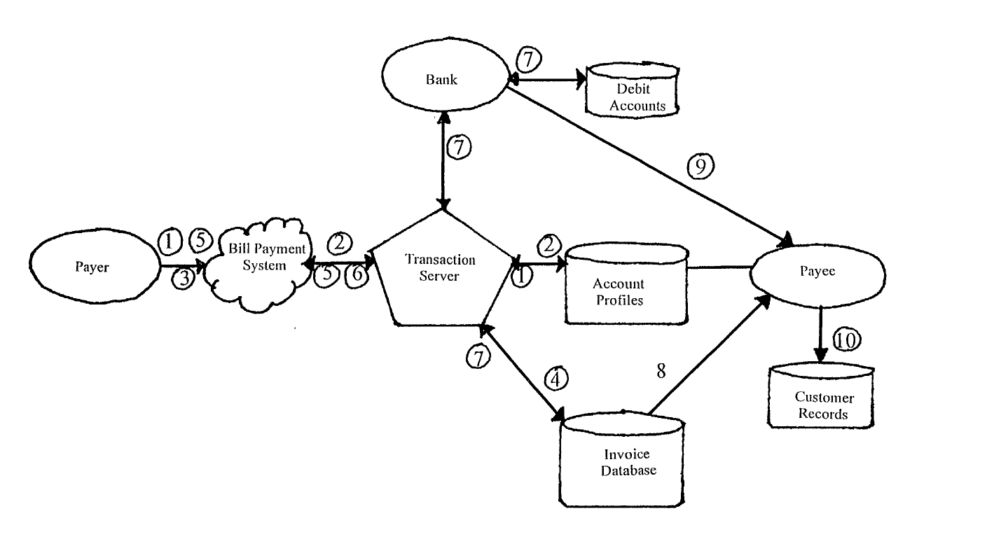

### DETAILED DESCRIPTION OF THE INVENTION

The system and method disclosed herein ensure the efficient, economical, and satisfactory completion of bill payment and reconciliation transactions via the Internet. It is understood that the present invention embodies any means or method capable of performing the functions described in this disclosure, and is not limited to those exemplified herein. In one embodiment, the method and system according to the present invention is described as follows:

Initially, the consumer establishes the prepaid account and a debit account with a participating financial institution. The financial institution, having customer debit and savings accounts as well as an electronic financial environment including a bank web server, electronically communicates with a transaction server having bill payment software, an invoice database, and an account profile database. The transaction server communicates with various merchants' servers, each having consumer records. The various merchants communicate electronically with the financial institutions.

In the first step, the consumer utilizes a personal computer to establish a communications link via the Internet with the bank server. Once communications are established, the consumer logs on to the bill payment system from a web page on the bank server.

The consumer views various web pages on the transaction server that provide account information. From the transaction server web pages, the consumer selects a view of a bill, and the transaction server populates a corresponding HTML bill template with data retrieved from the invoice database. After viewing the selected bill, the consumer selects a bill payment request option having an amount of payment.

In the second step, the transaction server compares the prepaid account balance of the consumer against the amount of the bill payment request. If prepaid account funds are insufficient to meet the bill payment request amount, then the transaction server notifies the consumer via the communications link, and offers an option to refill the prepaid account via an electronic transfer of funds from the consumer's debit account with the financial institution.

If prepaid account funds are sufficient to consummate the transaction, then the transaction server debits the consumer's prepaid account, generates an updated invoice from the invoice database reflecting the current payment, then records and transmits the transaction information (account reconciliation information) to the merchant. The transaction server bundles multiple account reconciliation information for batch transmissions to participating merchants' servers at predetermined intervals; e.g., at completion of a business day.

In the third step, the bank server electronically posts funds transfers corresponding to the transaction records transmitted to the merchants' servers in the previous step. The bank server completes the posting within the predetermined time interval; e.g., within the same business day in which the consumer selected the bill payment request.

In the last step, and after receipt of the funds transfer from the bank server, the merchant's server updates the consumer's record to reflect payment. Generally, this step is accomplished within the predetermined interval previously referenced.

Although not limited in this regard, the steps outlined above may be executed in conjunction with the Transaction Server described in U.S. patent application Ser. Nos. 09/256,540; 09/721,322 and 09/561,236, the entire contents of both of which are incorporated herein by reference. Reference is made to the FIGURE, wherein steps from payer request to payee recording payment are as follows:

1) Customer logs onto the bill payment system from bank web page;

2) The Transaction Server provides information from Account Profiles DB;

3) Customer selects view of a bill;

4) HTML bill template is populated with data and returned from Invoice database;

5) Customer selects “Pay Bill”, requesting bill payment from the Transaction System;

6) If insufficient funds, the Transaction Server rejects the request, and the customer is offered option to refill bill pay debit account from checking or savings;

7) If sufficient funds, the Transaction Server sends update to invoice DB reflecting payment, debits customer bill payment account, and records transaction for payee;

8) At end of business day, batched Account Reconciliation information is sent to participating payees for account reconciliation;

9) Same business day, bank posts funds transfer to payee for that day's batched payments; and

10) Same business day, Payee updates customer records to reflect payment.

Having illustrated and described the principles of the system and method of the present invention in various embodiments, it should be apparent to those skilled in the art that the embodiment can be modified in arrangement and detail without departing from such principles. For example, the physical manifestation of the media may be changed if preferred. Therefore, the illustrated embodiments should be considered only as example of the invention and not as a limitation on its scope.

I claim:

1. A method of performing an electronic bill payment transaction via a computer network between a user having an account device, an administrator of the account device, a transaction system, and a merchant having a server, the method comprising the steps of:
transmitting a request for payment from the user to the transaction server;
comparing the request against the account device to ensure sufficient funds for payment of the request;
if the funds are determined to be sufficient, debiting the account device of the user;
recording the payment transaction; and
transferring a copy of the electronic bill payment transaction recorded in the previous step and electronic funds to the server of the merchant.
